(19) United States
(12) Patent Application Publication
(10) Pub. No.: US 2010/0103112 A1
(43) Pub. Date: Apr. 29, 2010

(54) FABRIC TYPE INPUT DEVICE

(75) Inventors: Hoi-Jun Yoo, Daejeon (KR); Yongsang KIM, Daejeon (KR); Hyejung Kim, Daejeon (KR)

Correspondence Address: PRYOR CASHMAN, LLP, 7 Times Square, NEW YORK, NY, 10036-6569, US

(73) Assignee: Korea Advanced Institute of Science and Technology, Daejeon (KR)

(21) Appl. No.: 12/425,531

(22) Filed: Apr. 17, 2009

(30) Foreign Application Priority Data
Apr. 22, 2008 (KR) 10-2008-0037353

(51) Int. Cl. G06F 3/02

(52) U.S. Cl. 345/169

(57) ABSTRACT

There is a fabric type input device. The fabric type input device comprise a fabric type electrode unit comprising first and second fabric type electrodes formed opposite to each other, the first and second fabric type electrodes each comprising a fabric and a lead pattern formed by patterning a conductive material on the fabric, a fabric type substrate unit interposed between the first and second fabric type electrodes so that the first and second fabric type electrodes are spaced apart from each other, the fabric type substrate unit having a connection hole formed so that the first and second fabric type electrodes are in contact with each other and a control unit supplying an input signal to the fabric type electrode unit, the control unit sensing the supplied input signal. The fabric type input device is formed using a fabric patterned with a conductive material, thereby minimizing foreign-body feeling.

### CROSS-REFERENCE TO RELATED APPLICATION

This application claims priority from Korean Patent Application No. 10-2008-0037353, filed on Apr. 22, 2008, the disclosure of which is hereby incorporated herein by reference in its entirety as if set forth fully herein.

### BACKGROUND OF INVENTION

1. Field of the Invention

The present invention relates to a fabric type input device.

2. Discussion of the Related Art

Recently, as the use of electronic devices such as notebook computers, Personal digital assistants (PDAs) and mobile terminals has increased, keyboards used as input devices of portable electronic devices have also been manufactured and come into the market. Generally, a portable keyboard is formed of a silicon material so that a user can carry the portable keyboard which is rolled up or adhered to user's clothes. However, an input device such as a portable keyboard formed of a silicon material is formed of a material completely different from that of clothes. For this reason, when the input device is adhered to or inserted into the clothes, user's inconvenience such as foreign-body feeling may be caused.

Meanwhile, a thin film transistor is used for a conventional input device. A peripheral tool having characteristics different from those of fabrics is required to implement the conventional input device. Accordingly, when a user wears clothes to which the conventional input device is adhered, the user may provoke a foreign-body feeling from the conventional input device. Further, it is inconvenient that the conventional input device should be separated from the user's clothes when the user washes the clothes to which the conventional input device is adhered.

### SUMMARY OF THE INVENTION

The present invention is conceived to solve the aforementioned problems. Accordingly, an object of the present invention is to provide a digital input device which can minimize foreign-body feeling and be washable.

The fabric input device comprises: a fabric type electrode unit comprising a first type electrode and a second fabric type electrode formed opposite to each other, the first type electrode and the second fabric type electrodes each comprising a fabric and a lead pattern formed by patterning a conductive material on the fabric; a fabric type substrate unit interposed between the first fabric type electrode and the second fabric type electrode so that the first fabric type electrode and the second fabric type electrode are spaced apart from each other, the fabric type substrate unit having a connection hole formed so that the first fabric type electrode and the second fabric type electrode are in contact with each other; and a control unit supplying an input signal to the fabric type electrode unit, the control unit sensing the supplied input signal.

The conductive material comprises silver, polymer, polyester and cyclohexanone.

The control unit comprises a signal supply unit connected to the first fabric type electrode to supply the input signal; and a signal sensor connected to the second fabric type electrode to sense the supplied input signal.

The fabric type input device further comprises a signal transfer unit transferring the input signals between the control unit and the fabric type electrode unit.

The signal transfer unit comprises a first connection line connected between the first fabric type electrode and the signal supply unit; and a second connection line connected between the second fabric type electrode and the signal sensor, and wherein the first connection line and the second connection line comprise a conductive fiber.

When external pressure is applied to the fabric type electrode unit, the control unit senses the input signal supplied to the fabric type electrode unit while the respective lead patterns of the first fabric type electrode and the second fabric type electrode are connected to each other through the connection hole.

The fabric type input device comprises: a fabric type electrode unit having a first fabric type electrode and a second fabric type electrodes formed opposite to each other, the first fabric type electrode and the second fabric type electrode each comprising a fabric and a lead pattern formed by patterning a conductive material on the fabric; an elastic unit providing a spacing distance between the first fabric type electrode and the second fabric type electrode, the elastic unit being formed so that the spacing distance is elastically changed; and a sensor sensing a variation of the capacitance of the fabric type electrode unit.

The fabric type input device further comprises a connection unit connected between the fabric type electrode unit and the sensor.

The connection unit comprises a first connection line connected between the first fabric type electrode and one end of the sensor; and a second connection line connected between the second fabric type electrode and the other end of the sensor.

The first connection line and second connection line comprise a conductive fabric.

The conductive material comprises silver, polymer, polyester and cyclohexanone.

When external pressure is applied to the fabric type electrode unit, the sensor senses the variation of the capacitance depending on a change in the spacing distance between the first fabric type electrode and the second fabric type electrode.

The elastic unit comprises at least one of a sponge and a fiber.

The fabric input device comprises: a fabric type electrode unit comprising a fabric and a first lead pattern and a second lead pattern formed by patterning a conductive material on the fabric; and a sensor sensing a variation of the capacitance of the fabric type electrode unit.

The fabric type input device further comprises a connection unit connected between the fabric type electrode unit and the sensor.

The connection unit comprises a first connection line connected between the first lead pattern and one end of the sensor; and a second connection line connected between the second lead pattern and the other end of the sensor.

The first connection line and the second connection line comprise a conductive fiber.

The conductive material comprises silver, polymer, polyester and cyclohexanone.

The first lead pattern and the second lead pattern are patterned in an interdigital form.

The sensor senses the variation of the capacitance generated between the first lead pattern and the second lead pattern by contact between the fabric type electrode unit and a user.

The fabric input device comprises: a fabric type electrode unit comprising a first fabric type electrode and a second fabric type electrode formed opposite to each other, the first fabric type electrode and the second fabric type electrode each comprising a fabric and a lead pattern formed by patterning a conductive material on the fabric; an elastic unit providing a spacing distance between the first fabric type electrode and the second fabric type electrode, the elastic unit being formed so that the spacing distance is elastically changed; and a control unit supplying a first signal having a specific frequency and intensity to the fabric type electrode unit, the control unit sensing a variation of the intensity of a second signal induced by the supplied the first signal.

The control unit comprises a signal supply unit supplying the first signal to the first fabric type electrode; and a signal sensor sensing the variation of the intensity of the second signal induced to the second fabric type electrode.

The fabric type input device further comprises a signal transfer unit transferring the first signal and the second signal between the fabric type electrode unit and the control unit.

The signal transfer unit comprises first connection lines respectively connected to one and the other ends of the first fabric type electrode from the signal supply unit; and second connection lines respectively connected to one and the other ends of the second fabric type electrode from the signal sensor.

The first connection lines and second connection lines comprise a conductive fiber.

The conductive material comprises silver, polymer, polyester and cyclohexanone.

The lead patterns are patterned in a spiral coil form.

When the first signal is applied to the first fabric type electrode and external pressure is applied to the fabric type electrode unit, the control unit senses the variation of the intensity of the second signal induced to the second fabric type electrode spacing distance depending on a change in the spacing distance between the first fabric type electrode and the second fabric type electrode.

A fabric type input device according to embodiments of the present invention is manufactured using a fabric patterned with a conductive material, a conductive fiber for electrical connection, so that foreign-body feeling can be minimized. Further, the fabric type input device is washable without separating the fabric type input device from clothes.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1 is a drawing illustrating a fabric type input device using a switch mode according to a first embodiment of the present invention;

FIG. 2 is a drawing illustrating a fabric type input device using a capacitance variation sensing mode according to a second embodiment of the present invention;

FIG. 3 is a drawing illustrating a fabric type input device using a capacitance variation sensing mode according to a third embodiment of the present invention;

FIG. 4 is a drawing illustrating a fabric type input device using a mutual inductance variation sensing mode according to a fourth embodiment of the present invention; and

FIG. 5 is a drawing illustrating an array of fabric type input devices attached to clothes according to the first to fourth embodiments of the present invention.

### DETAILED DESCRIPTION OF THE INVENTION

Hereinafter, exemplary embodiments of the present invention will be described in detail with reference to the accompanying drawings.

### First Embodiment

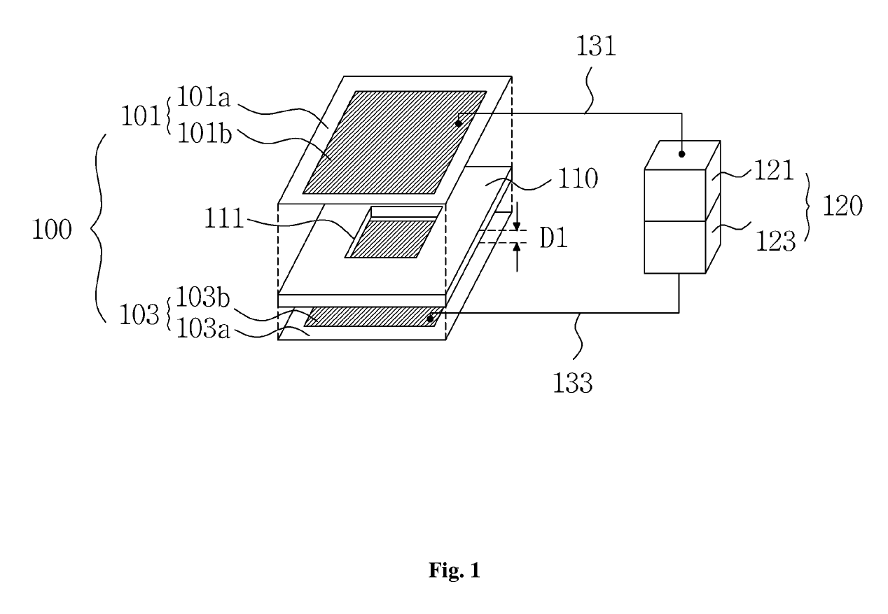

FIG. 1 is a drawing illustrating a fabric type input device using a switch mode according to a first embodiment of the present invention.

Referring to FIG. 1, the fabric type input device according to the first embodiment of the present invention comprises a fabric type electrode unit 100, a fabric type substrate unit 110 and a control unit 120.

The fabric type electrode unit 100 comprises a first fabric type electrode 101 and a second fabric type electrode 103 opposite to each other at a predetermined spacing distance D1. The first fabric type electrode 101 comprises a fabric 101a and a lead pattern 101b formed by patterning a conductive material on the fabric 101a. The second fabric type electrode 103 comprises a fabric 103a and a lead pattern 103b having a conductive material patterned on the fabric 103a. The lead patterns 101b and 103b formed in the first and second fabric type electrodes 101 and 103 may be formed by depositing or coating a conductive material on the fabrics 101a and 103a using a mask, respectively. The conductive material may comprise silver, polymer, polyester and cyclohexanone.

The fabric type substrate unit 110 is interposed between the first and second fabric type electrodes 101 and 103 so that the first and second fabric type electrodes 101 and 103 are spaced apart from each other. Accordingly, the fabric type substrate unit 110 provides the spacing distance D1 between the first and second fabric type electrodes 101 and 103. A connection hole 111 passing through the top and bottom of the fabric type substrate unit 110 is formed at a predetermined region so that the spaced first and second fabric type electrodes 101 and 103 are in contact with each other. For example, when pressure is applied to the first fabric type electrode 101, the first fabric type electrode 101 is in contact with the second fabric type electrode 103 through the connection hole 111. When the first and second fabric type electrodes 101 and 103 are in contact with each other, the respective lead patterns 101b and 130b can also be electrically connected to each other while being in contact with each other. When the pressure applied to the first fabric type electrode 101 is removed, the respective lead patterns 101b and 103b being in contact with each other are separated from each other due to the elasticity of a fabric possessed by the first and second fabric type electrodes 101 and 103.

The control unit 120 comprises a signal supply unit 121 connected to the lead pattern 101b of the first fabric type electrode 101 and a signal sensor 123 connected to the lead pattern 103b of the second fabric type electrode 103. The signal supply unit 121 supplies an input signal having the form of current to the first fabric type electrode 101. The signal sensor 123 senses an input signal supplied to the first fabric type electrode 101 from the second fabric type electrode 103. Therefore, when the respective lead patterns 101b and 103b are in contact with each other through the connection hole 111 of the fabric type substrate unit 110, the input signal supplied from the signal supply unit 121 can be sensed by the signal sensor 123. Accordingly, the fabric type input device senses an input signal through the signal sensor 123, thereby receiving a user's input.

Signal transfer unit 131 and 133 connects the fabric type electrode unit 100 and the control unit 120 to transfer an input signal. The signal transfer unit 131 and 133 comprises a first connection line 131 connected between the first fabric type electrode 101 and the signal supply unit 121, and a second connection line 133 connected between the second fabric type electrode 103 and the signal sensor 123. The first and second connection lines 131 and 133 may comprise a conductive fiber. The first and second connection lines 131 and 133 are sewed to the respective lead patterns 101b and 103b, to be electrically connected to the fabric type electrode unit 100.

### Second Embodiment

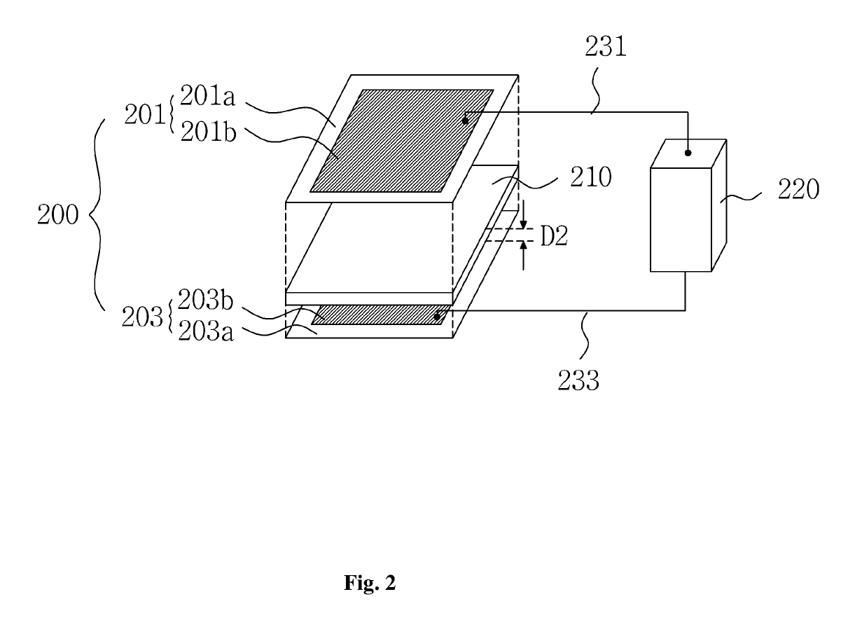

FIG. 2 is a drawing illustrating a fabric type input device using a capacitance variation sensing mode according to a second embodiment of the present invention.

Referring to FIG. 2, the fabric type input device according to the second embodiment of the present invention comprises a fabric type electrode unit 200, an elastic unit 210 and a sensor 220.

The fabric type electrode unit 200 comprises first and second fabric type electrodes 201 and 203 formed opposite to each other. The first fabric type electrode 201 comprises a fabric 201a, a lead pattern 201b having a conductive material patterned on the fabric 201a. The second fabric type electrode 203 comprises a fabric 203a and a lead pattern 203b having a conductive material patterned on the fabric 203a. The first and second fabric type electrodes 201 and 203 constitute a capacitor having the two lead patterns 201b and 203b as electrode layers. The lead patterns 201b and 203b formed in the first and second fabric type electrodes 201 and 203 may be formed by depositing or coating a conductive material on the fabrics 201a and 203a using a mask, respectively. The conductive material may comprise silver, polymer, polyester and cyclohexanone.

The elastic unit 210 is interposed between the first and second fabric type electrodes 201 and 203. Accordingly, the elastic unit 210 provides a spacing distance D2 between the first and second fabric type electrodes 201 and 203. The elastic unit 210 comprises a sponge or fabric and has an elastic force. Accordingly, the elastic unit 210 can allow the spacing distance D2 between the first and second fabric type electrodes 201 and 203 to be elastically changed. For example, when pressure is applied to the first fabric type electrode 201, the spacing distance D2 between the first and second fabric type electrodes 201 and 203 decreases. When the pressure applied to the first fabric type electrode 201 is removed, the spacing distance D2 is restored to the initial state. Therefore, the fabric type input device according to the second embodiment of the present invention can perform switching operations using the elastic forces of the fabrics 201a and 203a possessed by the first and second fabric type electrodes 201 and 203 and the elastic force possessed by the elastic unit 210.

The sensor 220 is connected to the lead patterns 201b and 203b of the first and second fabric type electrodes 201 and 203 to sense a variation of the capacitance between the lead patterns 201b and 203b depending on the spacing distance D2 between the first and second fabric type electrodes 201 and 203. That is, as the spacing distance D2 between the first and second fabric type electrodes 201 and 203 is varied, the capacitance between the respective lead patterns 201b and 203b is varied, and the sensor 220 senses the varied capacitance. Therefore, the fabric type input device according to the second embodiment of the present invention senses a variation of the capacitance between the first and second fabric type electrodes 201 and 203, thereby receiving a user's input.

The fabric type input device comprises a connection unit 231 and 233 that allow the fabric type electrode 200 to be electrically connected to the sensor 220. The connection unit 231 and 233 comprises a first connection line 231 connecting the first fabric type electrode 201 to one end of the sensor 220, and a second connection line 233 connecting the second fabric type electrode 203 to the other end of the sensor 220. The connection unit 231 and 233 transfers a signal with respect to a variation of the capacitance generated from the first and second fabric type electrodes 201 and 203 to the sensor 220. The first and second connection lines 231 and 233 comprise a conductive fiber and allow the fabric type electrode unit 200 and the sensor 220 to be electrically connected to each other. The first and second connection lines 231 and 233 are sewed to the respective lead patterns 201b and 203b, to be electrically connected to the fabric type electrode unit 200.

### Third Embodiment

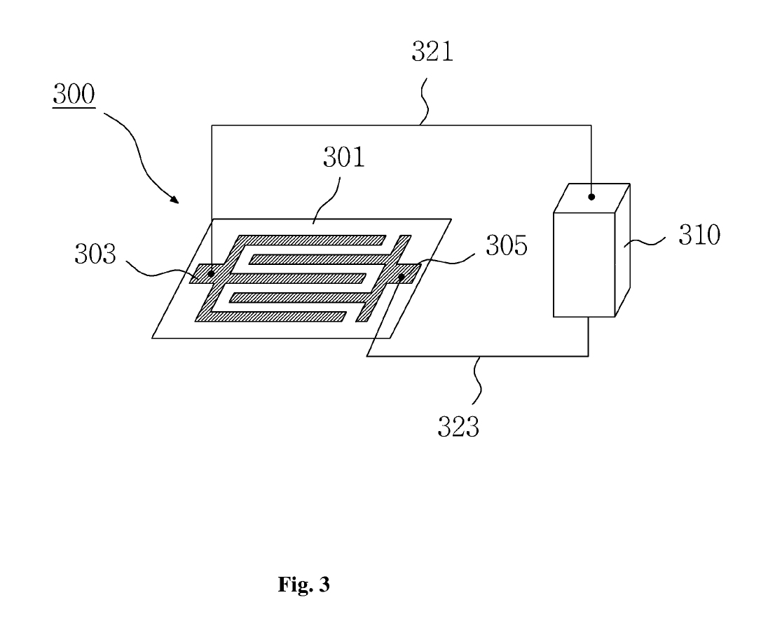

FIG. 3 is a drawing illustrating a fabric type input device using a capacitance variation sensing mode according to a third embodiment of the present invention.

Referring to FIG. 3, the fabric type input device according to the third embodiment of the present invention comprises a fabric type electrode unit 300 and a sensor 310.

The fabric type electrode unit 300 comprises a fabric 301, first and second lead patterns 303 and 305 formed by patterning a conductive material on the fabric 301. As shown in FIG. 3, the first and second lead patterns 303 and 305 may be patterned in an interdigital form. The first and second lead patterns 303 and 305 may be formed by depositing or coating a conductive material on the fabric 301 using a mask. The conductive material may comprise silver, polymer, polyester and cyclohexanone. When the fabric type electrode unit 300 is in contact with a user's finger or the like, capacitance between the first and second lead patterns 303 and 305 is varied.

The sensor 310 is connected between the first and second lead patterns 303 and 305 of the fabric type electrode unit 300 to sense a variation of the capacitance generated from the fabric type electrode unit 300. Therefore, the fabric type input device senses a variation of the capacitance generated from the fabric type electrode unit 300, receiving a user's input.

The fabric type input device comprises a connection unit 321 and 323 that allows the fabric type electrode unit 300 to be electrically connected to the sensor 310. The connection unit 321 and 323 comprises a first connection line 321 connected between the first lead pattern 303 and one end of the sensor 310, and a second connection line 323 connected between the second lead pattern 305 and the other end of the sensor 310. The connection unit 321 and 323 transfers a signal with respect to a variation of the capacitance generated from the fabric type electrode unit 300 to the sensor 310. The first and second connection lines 321 and 323 comprise a conductive fiber. The first and second connection lines 321 and 323 are respectively sewed to the first and second lead patterns 303 and 305, to be electrically connected to the fabric type electrode unit 300.

### Fourth Embodiment

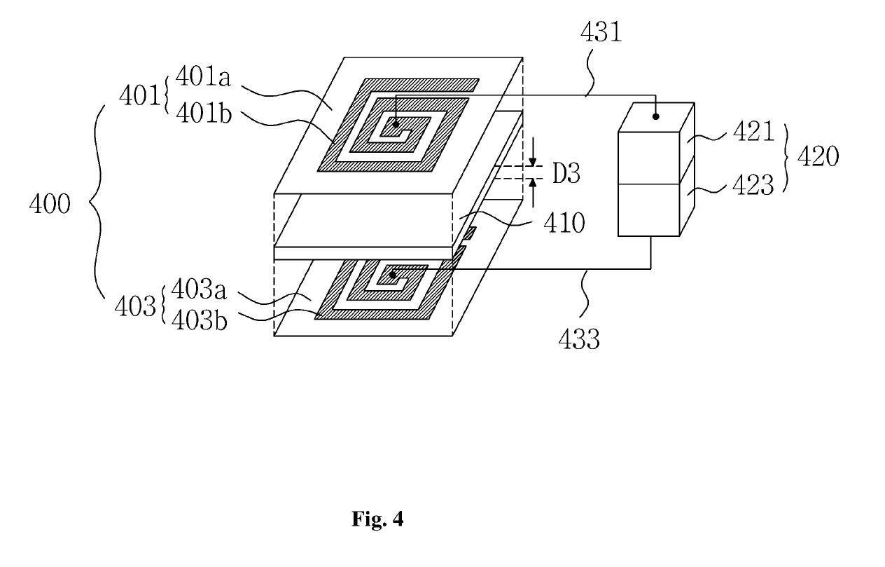

FIG. 4 is a drawing illustrating a fabric type input device using a mutual inductance variation sensing mode according to a fourth embodiment of the present invention.

Referring to FIG. 4, the fabric type input device according to the fourth embodiment of the present invention comprises a fabric type electrode unit 400, an elastic unit 410 and a control unit 420.

The fabric type electrode unit 400 comprises first and second fabric type electrodes 401 and 403 formed opposite to each other. The first fabric type electrode 401 comprises a fabric 401a and a lead pattern 401b formed by patterning a conductive material on the fabric 401a. The second fabric type electrode 403 comprises a fabric 403a and a lead pattern 403b formed by patterning a conductive material on the fabric 403a. The lead patterns 401b and 403b formed in the first and second fabric type electrodes 401 and 403 may be formed by depositing or coating a conductive material on the fabrics 401a and 403a using a mask, respectively. The conductive material may comprise silver, polymer, polyester and cyclohexanone.

The elastic unit 410 is interposed between the first and second fabric type electrodes 401 and 403 so that the first and second fabric type electrodes 401 and 403 are spaced apart from each other. Accordingly, the elastic unit 410 provides a spacing distance D3 between the first and second fabric type electrodes 401 and 403. The elastic unit 410 comprises a sponge or fabric and has an elastic force. Therefore, the elastic unit 410 can allow the spacing distance D3 between the first and second fabric type electrodes 401 and 403 to be elastically changed. When pressure is applied to the first fabric type electrode 410, the spacing distance D3 between the respective lead patterns 410b and 403b decreases. When the pressure applied to the first fabric type electrode 401 is removed, the spacing distance D3 between the respective lead patterns 401b and 403b is restored to the initial state. Accordingly, the spacing distance D3 is changed by the elastic forces of the fabrics 401a and 403a possessed by the first and second fabric type electrodes 401 and 403 and the elastic force possessed by the elastic unit 410, so that the fabric type input device according to the fourth embodiment of the present invention can perform switching operations.

The control unit 420 comprises a signal supply unit 421 connected to the lead pattern 410b of the first fabric type electrode 410 and a signal sensor 423 connected to the lead pattern 403b of the second fabric type electrode 403. The signal supply unit 421 supplies a first signal having a specific frequency and intensity to the first fabric type electrode 401. The signal sensor 423 senses a variation of the intensity of a second signal induced to the second fabric type electrode 403 by the first signal. For example, when the first signal is applied to the first fabric type electrode 401 from the signal supply unit 421 and external pressure is applied to the first fabric type electrode 401, the spacing distance D3 between the first and second fabric type electrodes 401 and 403 is changed. The mutual inductance between the lead patterns 401b and 403b is varied depending on a change in the change in the spacing distance D3. At this time, the second signal is induced to the lead pattern 403b of the second fabric type electrode 403 by the change in the spacing distance D3. Therefore, the signal sensor 423 senses the variation of the intensity of the second signal induced to the lead pattern 403b of the second fabric type electrode 403, thereby receiving a user's input.

The fabric type input device comprises a signal transfer unit 431 and 433 that allows the fabric type electrode unit 400 to be electrically connected to the control unit 420. The signal transfer unit 431 and 433 comprises a first connection line 431 connected between the lead pattern 401b of the first fabric type electrode 401 and one end of the control unit 420, and a second connection line 433 connected between the lead pattern 403b of the second fabric type electrode 403 and the other end of the control unit 420. The signal transfer unit 431 and 433 transfers the first signal supplied from the signal supply unit 421 to the first fabric type electrode 401 and transfers the second signal induced from the second fabric type electrode 403 to the control unit 420. The first and second connection lines 431 and 433 comprise a conductive fiber and allow the fabric type electrode unit 400 to be electrically connected to the control unit 420. The first and second connection lines 431 and 433 are sewed to the respective lead patterns 401b and 403b, to be electrically connected to the fabric type electrode unit 400.

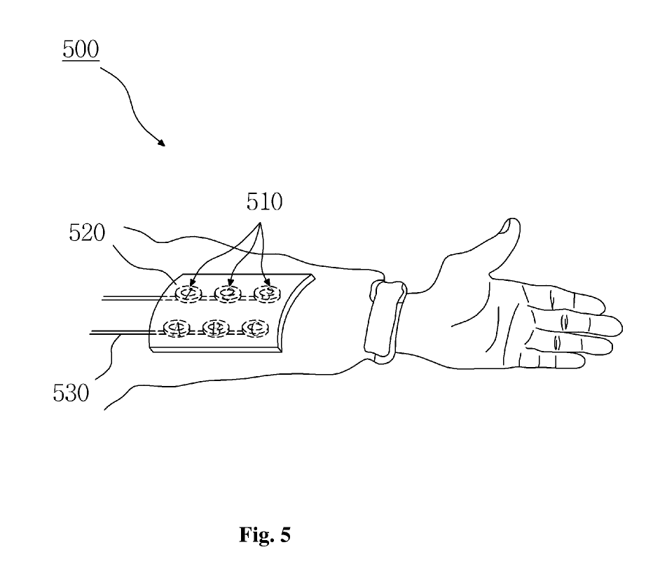

FIG. 5 is a drawing illustrating an array of fabric type input devices attached to clothes according to the first to fourth embodiments of the present invention.

As shown in FIG. 5, fabric type input devices 510 may be formed as an array 500 connected to a plurality of connection lines 530. The plurality of connection lines 530 are connected to a controller to transfer signals inputted to the fabric type input devices 510. A keypad 520 is formed on the fabric type input devices 510 formed as the array 500 so that when a user presses a key, an input generated by pressing the key can be recognized.

A fabric type input device according to embodiments of the present invention is manufactured using a fabric patterned with a conductive material, a conductive fiber for electrical connection, so that foreign-body feeling can be minimized. Further, the fabric type input device is washable without separating the fabric type input device from clothes.

While the present invention has been particularly shown and described with reference to exemplary embodiments thereof, it will be understood by those of ordinary skill in the art that various changes in form and details may be made therein without departing from the spirit and scope of the present invention as defined by the following claims. Therefore, the scope of the present invention should be understood within the scope of the present invention defined by the appended claims.

What is claimed is:

1. A fabric type input device, comprising:
a fabric type electrode unit comprising a first fabric type electrode and a second fabric type electrode formed opposite to each other, the first fabric type electrode and the second fabric type electrode each comprising a fabric and a lead pattern formed by patterning a conductive material on the fabric;
a fabric type substrate unit interposed between the first fabric type electrode and the second fabric type electrode so that the first fabric type electrode and the second fabric type electrode are spaced apart from each other, the fabric type substrate unit having a connection hole formed so that the first fabric type electrode and the second fabric type electrode are in contact with each other; and
a control unit supplying an input signal to the fabric type electrode unit, the control unit sensing the supplied input signal.

2. The fabric type input device of claim 1, wherein the conductive material comprises silver, polymer, polyester and cyclohexanone.

3. The fabric type input device of claim 1, wherein the control unit, comprises:
a signal supply unit connected to the first fabric type electrode to supply the input signal; and
a signal sensor connected to the second fabric type electrode to sense the supplied input signal.

4. The fabric type input device of claim 3, further comprising a signal transfer unit transferring the input signals between the control unit and the fabric type electrode unit,
wherein the signal transfer unit comprises:
a first connection line connected between the first fabric type electrode and the signal supply unit; and
a second connection line connected between the second fabric type electrode and the signal sensor, and
wherein the first connection line and the second connection line comprise a conductive fiber.

5. The fabric type input device of claim 1, wherein, when external pressure is applied to the fabric type electrode unit, the control unit senses the input signal supplied to the fabric type electrode unit while the respective lead patterns of the first fabric type electrode and the second fabric type electrode are connected to each other through the connection hole.

6. A fabric type input device, comprising:
a fabric type electrode unit comprising a first fabric type electrode and a second fabric type electrode formed opposite to each other, the first fabric type electrode and the second fabric type electrode each comprising a fabric and a lead pattern formed by patterning a conductive material on the fabric;
an elastic unit providing a spacing distance between the first fabric type electrode and the second fabric type electrode, the elastic unit being formed so that the spacing distance is elastically changed; and
a sensor sensing a variation of the capacitance of the fabric type electrode unit.

7. The fabric type input device of claim 6, further comprising a connection unit connected between the fabric type electrode unit and the sensor;
wherein the connection unit comprises:
a first connection line connected between the first fabric type electrode and one end of the sensor; and
a second connection line connected between the second fabric type electrode and the other end of the sensor, and
wherein the first connection line and the second connection line comprise a conductive fabric.

8. The fabric type input device of claim 6, wherein the conductive material comprises silver, polymer, polyester and cyclohexanone.

9. The fabric type input device of claim 6, wherein, when external pressure is applied to the fabric type electrode unit, the sensor senses the variation of the capacitance depending on a change in the spacing distance between the first fabric type electrode and the second fabric type electrode.

10. The fabric type input device of claim 6, wherein the elastic unit comprises at least one of a sponge and a fiber.

11. A fabric type input device, comprising:
a fabric type electrode unit comprising a fabric and a first lead pattern and a second lead pattern formed by patterning a conductive material on the fabric; and
a sensor sensing a variation of the capacitance of the fabric type electrode unit.

12. The fabric type input device of claim 11, further comprising a connection unit connected between the fabric type electrode unit and the sensor,
wherein the connection unit comprises:
a first connection line connected between the first lead pattern and one end of the sensor; and
a second connection line connected between the second lead pattern and the other end of the sensor, and
wherein the first connection line and the second connection line comprise a conductive fiber.

13. The fabric type input device of claim 11, wherein the conductive material comprises silver, polymer, polyester and cyclohexanone.

14. The fabric type input device of claim 11, wherein the first lead pattern and the second lead pattern are patterned in an interdigital form.

15. The fabric type input device of claim 11, wherein the sensor senses the variation of the capacitance generated between the first lead pattern and the second lead pattern by contact between the fabric type electrode unit and a user.

16. A fabric type input device, comprising:
a fabric type electrode unit comprising a first fabric type electrode and a second fabric type electrode formed opposite to each other, the fabric type electrode and the second fabric type electrode each comprising a fabric and a lead pattern formed by patterning a conductive material on the fabric;
an elastic unit providing a spacing distance between the first fabric type electrode and the second fabric type electrode, the elastic unit being formed so that the spacing distance is elastically changed; and
a control unit supplying a first signal having a specific frequency and intensity to the fabric type electrode unit, the control unit sensing a variation of the intensity of a second signal induced by supplied the first signal.

17. The fabric type input device of claim 16, wherein the control unit comprises:
a signal supply unit supplying the first signal to the first fabric type electrode; and
a signal sensor sensing the variation of the intensity of the second signal induced to the second fabric type electrode.

18. The fabric type input device of claim 17, further comprising a signal transfer unit transferring the first signal and the second signal between the fabric type electrode unit and the control unit,
wherein the signal transfer unit comprises:
first connection lines respectively connected to one end and the other end of the first fabric type electrode from the signal supply unit; and
second connection lines respectively connected to one end and the other end of the second fabric type electrode from the signal sensor, and
wherein the first connection lines and the second connection lines comprise a conductive fiber.

19. The fabric type input device of claim 16, wherein the conductive material comprise silver, polymer, polyester and cyclohexanone.

20. The fabric type input device of claim 16, wherein the lead patterns are patterned in a spiral coil form.

21. The fabric type input device of claim 16, wherein, when the first signal is applied to the first fabric type electrode and external pressure is applied to the fabric type electrode unit, the control unit senses the variation of the intensity of the second signal induced to the second fabric type electrode spacing distance depending on a change in the spacing distance between the first fabric type electrode and the second fabric type electrode.
